(19) United States
(12) Patent Application Publication
(10) Pub. No.: US 2004/0195947 A1
(43) Pub. Date: Oct. 7, 2004

(54) High brightness LED fixture for replacing high intensity dishcharge (HID) lamps

(76) Inventors: Jason Wilfred Clark, Milford, NH (US); Benjamin Osman Richardson, Mount Vernon, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/408,160

(22) Filed: Apr. 4, 2003

(51) Int. Cl. H01J 1/62

(52) U.S. Cl. 313/46; 313/498

(57) ABSTRACT

A high brightness light emitting diode array having emission faces forming a chassis and heat sink assemblies attached to the emission faces, each having at least one high brightness light emitting diode. The geometric arrangement of emission faces and the geometric arrangement of heat sink assemblies are selected to provide a desired emission pattern. Each heat sink assembly includes a heat sink plate mountable to an emission face, a high brightness light emitting diode mounted to the heat sink plate, and a thermally conductive, electrically isolating element between the diode and the heat sink plate.

### FIELD OF THE INVENTION

The present invention relates to high intensity lamps and, in particular, to solid state high intensity lamps for use in replacement of high intensity gas discharge or heated filament lamps.

### BACKGROUND OF THE INVENTION

High intensity lamps are used wherever there is a requirement for high levels of illumination and, in particular, high levels of illumination over a large area or at long distances from the light source or in conditions wherein light is obscured or absorbed, such as by rain, mist, fog or smoke. Typical applications include parking lot and sports field illumination, highway and road illumination, and so on.

Current high intensity discharge (HID) illumination devices are based upon the radiation of light by electrically energized gas molecules. That is, a gas or vapor is enclosed in a glass shell, such as a tube with electrodes at each end for passing an electric current through the enclosed gas or vapor. The electric current excites the gas molecules or atoms, that is, energizes the molecules or atoms, which subsequently discharge the acquired energy in the form of photon radiation at any of a wide range of selectable frequencies but, ideally in the visible frequencies. The frequency or frequencies of the emitted radiation is largely dependent upon the type of gas or gas mixture selected to fill the glass shell. Common gases include, for example, sodium, which emits a pinkish-orange light, mercury, which is toxic and expensive to produce but which emits blueish-white light, and xenon, which also emits blueish-white light is also expensive. In other instances, the emitting element of a HID lamp is a filament, such as a tungsten wire, that is heated by an electric current to emit visible radiation, but “incandesent filament” HID lamps may be regarded as generally similar in many respects to gas discharge HID lamps.

Conventional HID lamps, whether of the gas discharge type or the hot filament type, suffer from a number of problems and disadvantages. Among these problems are high operating and maintenance costs, mechanical complexity, manufacturing complexity, relatively short life, low efficiency and mechanical fragility. Conventional HID lamps also require mounts providing protection from shock, vibration and the environment, such as rain and snow, while providing adequate heat dissipation and the desired light emission pattern.

The methods of the prior art for addressing such problems are well known to those of ordinary skill in the arts and primarily involve careful engineering design of a conventional nature, but have proven generally unsatisfactory in many respects.

The present invention addresses these and other related problems of the prior art.

### SUMMARY OF THE INVENTION

The present invention is directed to a high brightness light emitting diode array having a plurality of emission faces forming a chassis to provide a light emission pattern and a plurality of heat sink assemblies, each heat sink assembly being attached to an emission face and having at least one high brightness light emitting diode mounted on the heat sink assembly. According to the present invention, the geometric arrangement of emission faces and the geometric arrangement of heat sink assemblies are selected to provide a desired emission pattern of the high brightness light emitting diodes mounted to the heat sink assemblies. The diode array also includes a power supply connected to the high brightness light emitting diodes to cause the emission of light from the high brightness light emitting diodes, and a mechanical mounting connector and an electrical connection for providing power to the power supply.

Also according to the present invention, a heat sink assembly includes a heat sink plate mountable to an emission face and having radiating fins for dissipating heat to surrounding air, a high brightness light emitting diode mounted to the heat sink plate with a thermally conductive and electrically isolating element between the diode and the heat sink plate, and electrical conductors for providing power to the diode and connected from the diode and leading through the heat sink plate to a back side of the emission face, the electrical conductors being electrically insulated from the heat sink plate and the emission face. The array also includes fastenings for attaching the heat sink plate to the emission face, and an electrical insulating plate between the heat sink plate and the emission face.

### BRIEF DESCRIPTION OF THE DRAWING(S)

The invention will now be described, by way of example, with reference to the drawings, wherein:

FIG. 1A is a diagrammatic exploded representation of a high brightness LED array;

FIG. 1B is a diagrammatic representation of a three dimensional emission pattern of a high brightness LED array;

FIG. 2A is a side view of a high brightness LED array;

FIG. 2B is a side view of a convention high intensity lamp;

FIG. 3 is a diagrammatic side view of a heat sink assembly for a high brightness LED; and,

FIGS. 4A through 41 are examples of emission face geometries for a range of emission patterns of high brightness LED arrays.

### DETAILED DESCRIPTION OF THE INVENTION

As will be described in the following, a Solid State High Intensity Discharge Lamp (SSHID) according to a presently preferred embodiment of the present invention is comprised of a plurality of High Brightness Light Emitting Diodes (HBLEDs), which are commercially available as a recent result of improvements in the chemical deposition and internal structural configurations ofconventional light emitting diodes (LEDs). HBLEDs, however, are now capable of emitting light, including white light, at emission levels currently comparable with those of HID (High Intensity Discharge) and incandescent lamps. The present invention recognizes that HBLEDs may thus be used in replacement for gas discharge or incandescent filament HID lamps, so long as the characteristics and physical structures of HBLEDs and the differences between HBLEDs and conventional gas discharge or incandescent filament HID lamps are recognized. An SSHID of the present invention provides methods and apparatus addressing these differences, and of constructing HID lamps of HBLEDs.

For example, an HBLED emits less power than does a conventional HID lamp has a significantly smaller, or narrower, pattern of light emission than does a conventional HID lamp, so that multiple HBLED units are required to obtain the same emitted power and emitted light pattern as a conventional HID lamp. Also, a HBLED requires adequate heat dissipation to operate at 100% power levels and to extend the life of the component, as does a conventional HID lamp.

HBLEDs, however, being relatively small and solid state, are less susceptible to shock and vibration and have an inherently longer operating life than gas discharge or incandescent filament lamps. In addition, each conventional HID lamp is a relatively large device that radiates light over a wide angle, up to 360°, so that a conventional lamp contains a relatively few large units radiating over wide angles. As a result, the emitted power of a conventional HID array can be adjusted only in relatively large increments and the emitted light pattern can be adjusted only by blocking or reflecting parts of the emitted light, adding to the cost and complexity of a conventional HID array, or fixture. In contrast, and while more HBLEDs than convention HID lamps are required for a given total emitted power level, the small size and typically narrower emitted light pattern of an HBLED allows the emitted power and emitted light pattern of an HBLED array to be adjusted much more finely using digital controls than can that of a conventional ballasted HID lamp array.

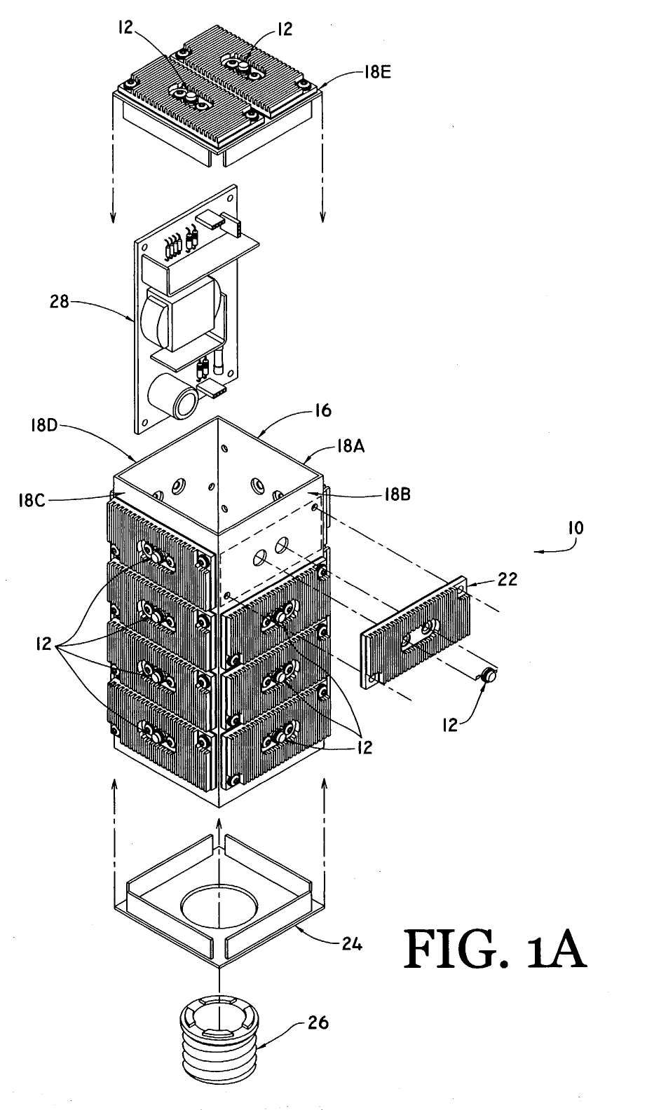

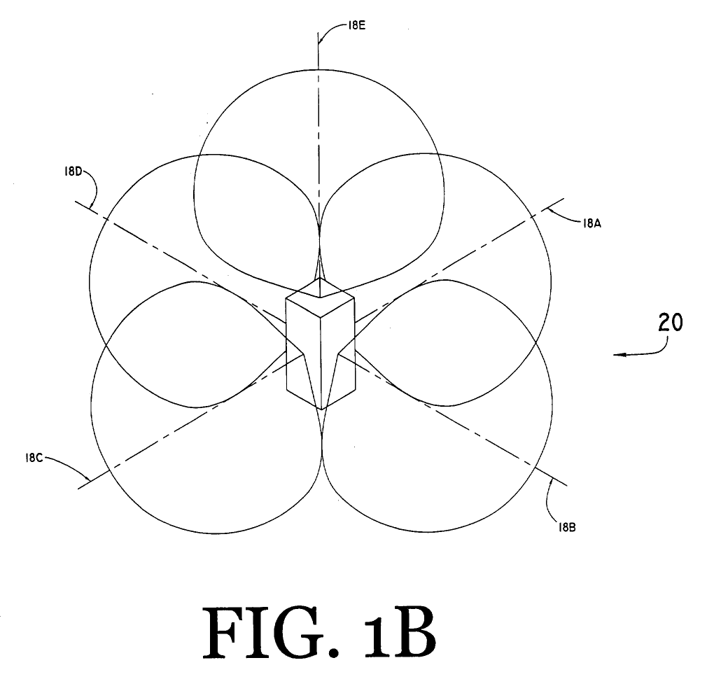

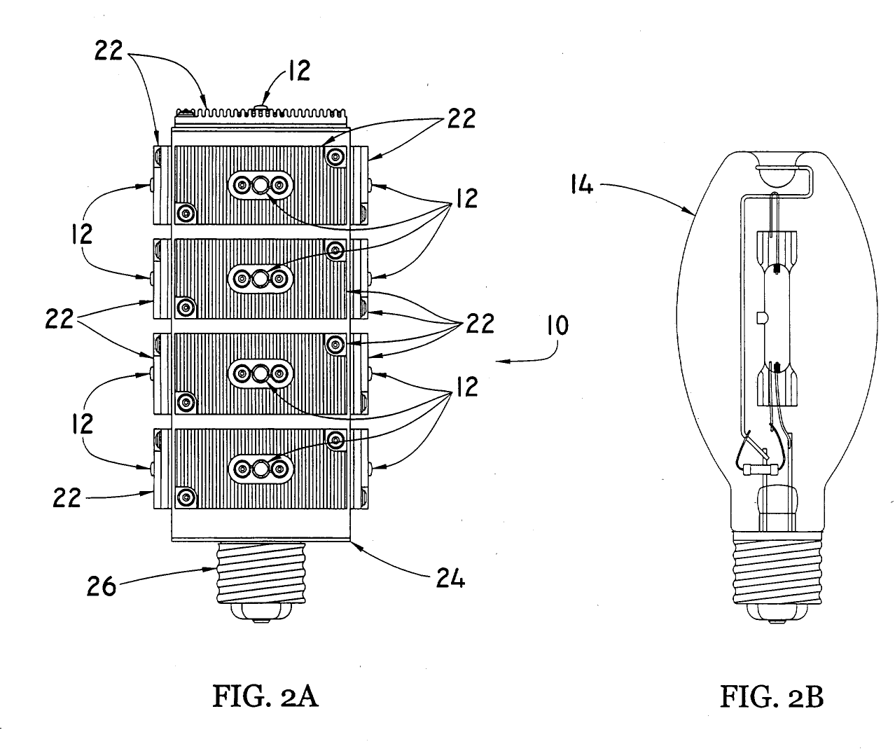

FIG. 1A is an expanded illustration an exemplary embodiment of an HBLED Array 10 comprised of a plurality of HBLEDs 12. For purposes of the present discussion, the HBLED Array 10 is intended to replace a conventional gas discharge or incandescent filament HID lamp or lamp array, and side views of the HBLED Array 10 of FIG. 1A and of a convention gas discharge or incandescent HID Lamp 14 are shown in FIGS. 2A and 2B, respectively, for purposes of illustration.

As illustrated in FIGS. 1A and 2A, a HBLED Array 10 includes a Chassis 16 having or comprised of a plurality of Emission Faces 18 wherein the number and orientation of Emission Faces 18 and the number and emission patterns of the HBLEDs 12 on each Emission Face 18 determine the total emitted power and the Emission Pattern 20 of the HBLED Array 10. In the exemplary embodiment illustrated in FIGS. 1A and 2A, for example, the HBLED Array 10 includes four Vertical Emission Faces 18A, 18B, 16C and 18D, and one Top Emission Face 18E and each HBLED 12 has an emission pattern that extends to approximately 45° from the perpendicular to the radiating face of the HBLED 12. As such, the HBLED Array 10 of FIGS. 1A and 2A will have an Emission Pattern 20, illustrated in FIG. 2B, approximating that of a conventional incandescent light bulb or HID lamp 14 as illustrated in FIG. 2B.

As shown in FIG. 1A, each HBLED 12 of HBLED Array 10 is mounted onto and into a Heat Sink Assembley 22, which in turn is mounted onto an Emission Face 18. The assembly of Chassis 16 with Emission Faces 18A through 18E and the Heat Sink Assemblies 22 with their respective HBLEDs 12 is mounted onto a Base 24, which in turn is mounted to a Connector 26.

In the embodiment illustrated in FIGS. 1A and 2A, Connector 26 is a conventional threaded connector similar to those found on standard light bulbs and comprises an electrical connector through which power is provided to the HBLED Array 10, and as a mechanical mount by which the HBLED Array 10 is mounted to a mechanical support or structure. It will be understood that this form of Connector 26 allows a HBLED Array 10 to be a one for one replacement for a wide range of conventional HID lamps. It will also be understood that in other embodiments the electrical and mechanical mounting functions of the illustrated Connector 26 may be fulfilled by separate electrical and mechanical connectors of any of a range of types. For example, and as will be discussed further in the following, Chassis 16 and Emission Faces 18 may be arranged in any of a wide variety of three dimensional geometries. For example, Emission Faces 18 may be arranged as a flat plane to provide directed but even illumination over a wide area, in a concave form to cast focused light in a concentrated pattern, such as provided by a floodlight or spotlight and focuses manner, or in a convex form, including a circle or spherical form, to provide illumination over a wider area. It will be recognized that the mechanical connector, or mount, for such geometries will be dependent upon both the geometry of the Emission Faces 18 and the structure to which the HBLED Array 10 is to be mounted, as will the specific form of the electrical connector. The construction of such mechanical and electrical mounts and connections, however, will be familiar to those of ordinary skill in the arts and as such will not be discussed in further detail herein.

Lastly, it will be readily understood by those of ordinary skill in the relevant arts that a LED or HBLED 12 will require different forms of electrical power than will convention gas discharge or incandescent filament HID lamps. For this reason, a HBLED Array 10 will typically include a Power Supply 28 connected from an electrical Connector 26 and providing appropriate power outputs to the HBLEDs 12. It will be noted that the design of such power supplies, and the wiring within a HBLED Array 10, will be well understood by those of ordinary skill in the relevant arts, and as such are not shown in detail in FIG. 1A or discussed in further detail herein. It should also be noted that a Power Supply 28 may be located outside of the HBLED Array 10, with the power from the supply being provided to the HBLED Array 10 through Connector 26, and that a Power Supply 28 may include such features as a dimming control or an on/off switch operated by ambient light conditions or an on/off switch activated by motion. In this regard, it should be noted that the turn-on/turn-off time of HBLEDs 12 is relatively instantaneous compared to conventional HID lamps, and do not require the “re-strike” times typical of conventional HID lamps.

Next considering heat dissipation for, or removal, for the HDLEDs 12, the present invention recognizes that while HBLEDs 12 are highly efficient in comparison to conventional HID lamps and that a proportionately lower percentage of the power input to the HBLEDs 12 is dissipated as heat rather than as emitted light. It is also recognized, however, that HBLEDs 12 are physically smaller per unit power than are conventional HID lamps, so that the HBLEDs 12 must be provided with effective heat dissipation in order to allow the HBLEDs 12 to operate at or near 100% rated power and to extend the operating life of the HBLEDs 12. It is for this reason that, as discussed above, each HBLED 12 is preferably mounted into a Heat Sink Assembly 22.

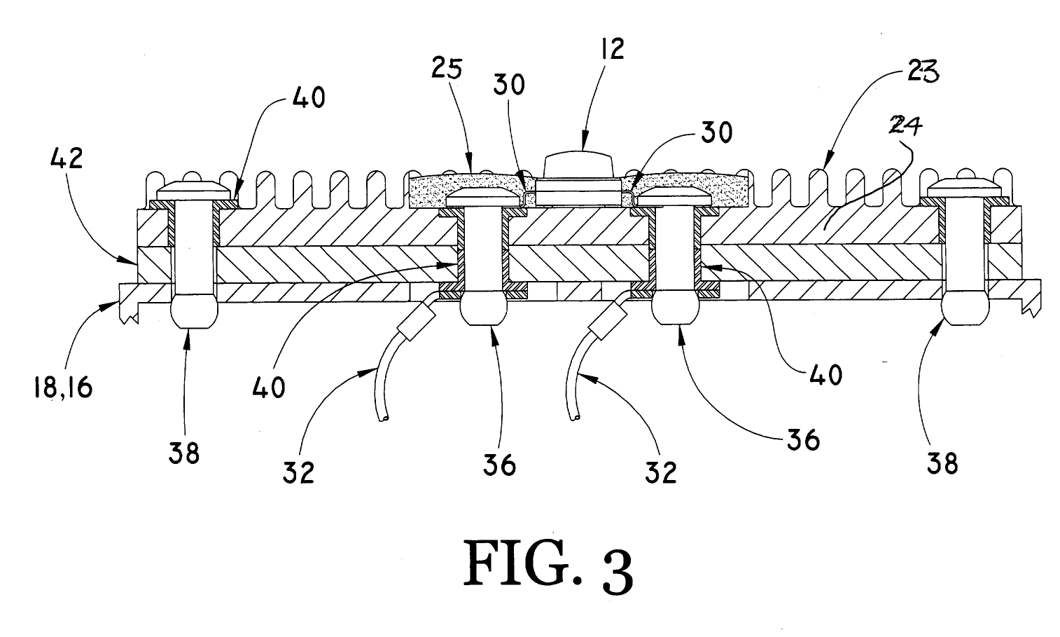

A typical Heat Sink Assembly 22 mounting a single HBLED 12 is illustrated in FIG. 3, wherein it is shown that the HBLED 12 is mounted onto and into a Heat Sink Plate 24 absorbing heat from the HBLED 12 and having Fins 23 to facilite heat dissipation into the surrounding air. The HBLED 12 is surrounded by and embedded in cast Thermal Connection Epoxy 25, which facilitates heat transfer to Heat Sink Plate 24 while electrically isolating the HBLED 12 from the Heat Sink Plate 24. Electrical Leads 30 from the HBLED 12 are connected to Electrical Connection 32 on the Back Side 34 of Heat Sink Assembly 22 through Conductive Paths 36, which may be comprised of, for example, wires, screws or, as illustrated, conductive rivets. As shown, the Heat Sink Assembly 22 is mounted to an Emission Face 18 of Chassis 16 by Fasteners 38, which may be any conventional fastening means, such as screws, bolts, epoxy or rivets, as illustrated in FIG. 3. It will be noted that conductive Paths 36 and other potentially conductive elements, such as Fasteners 38, are insulated from the Heat Sink Plate 24 and from Chassis 16 by means of Insulating Elements 40, such as insulating sleeves around the rivets. It will be further noted that Heat Sink Plate 24 is insulated from the Emission Face 18 and Chassis 16 by an electrical Insulating Plate 42, which may be of any of a range of materials and thicknesses.

Lastly in this regard, it should be noted that a Heat Sink Assembly 22 may be constructed to mount a plurality of HBLEDs 12, rather than a single HBLED 12, by methods well known to those of ordinary skill in the arts, and that many other configurations and shapes of Heat Sink Assembly 22 may be used, as will be well known to those of ordinary skill in the arts. Also, in certain simplified embodiments an Emission Face 18 may be utilized as the Heat Sink Plate 24 by mounting a HBLED 12 directly to the Emission Face 18 with suitable insulating elements, such as a thermally conductive by electrically Insulating Plate 42 and appropriate Insulating Elements 40 to isolate Electrical Leads 30 from the Emission Face 18. The Emission Face 18 and Chassis 16 may also be employed as one path of Paths 36, such as a ground path, by connecting the appropriate Electrical Lead 30 to the Emission Face 18. It should also be noted, however, that heat dissipation with this construction is not as efficient as with the Heat Sink Assemblies 22 described above, and that eddy currents in the Chassis 16 due to using the Chassis 16 as a power ground may also decrease the efficiency of the unit.

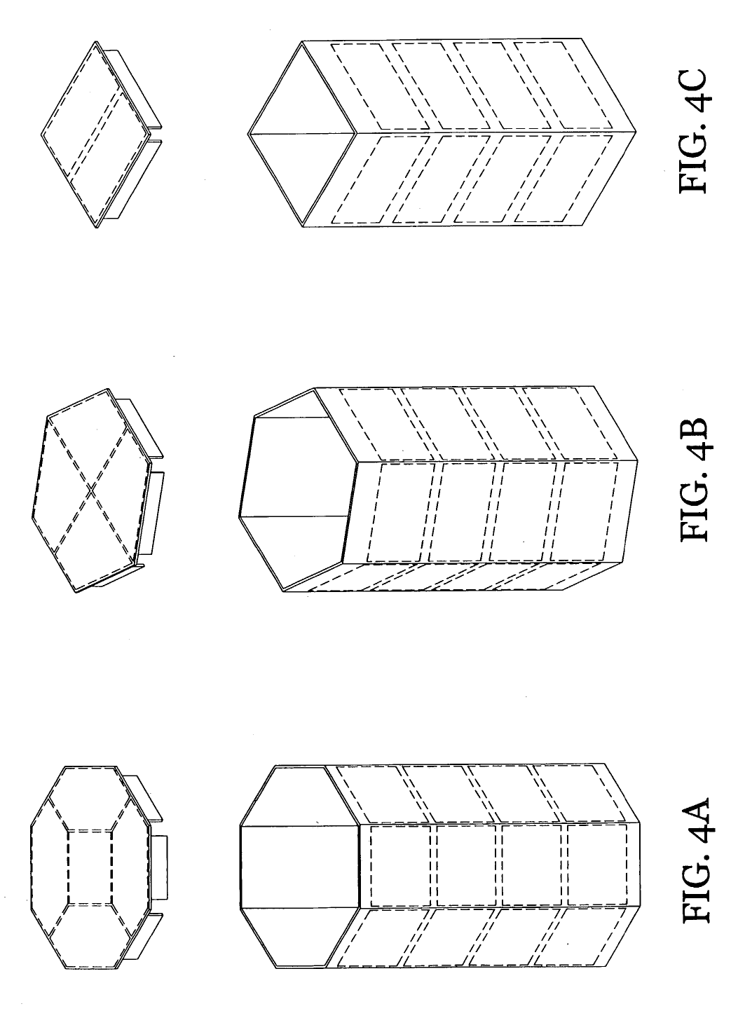

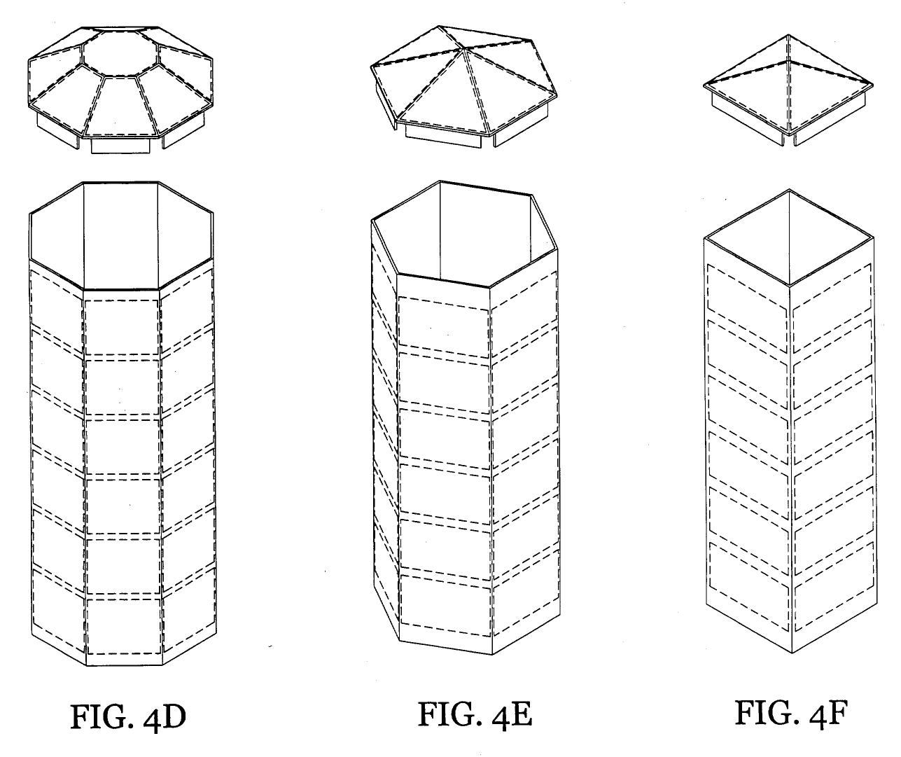

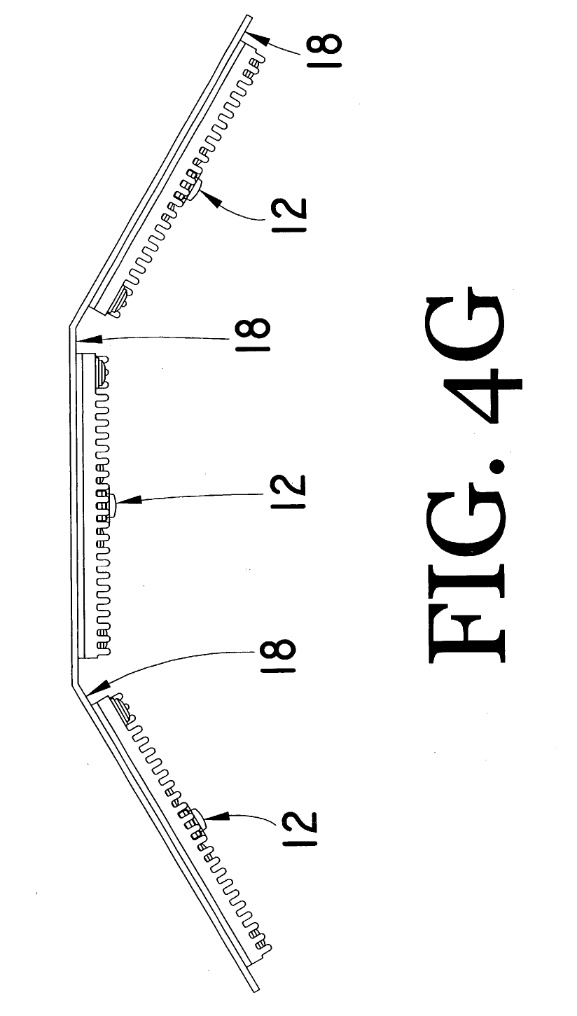

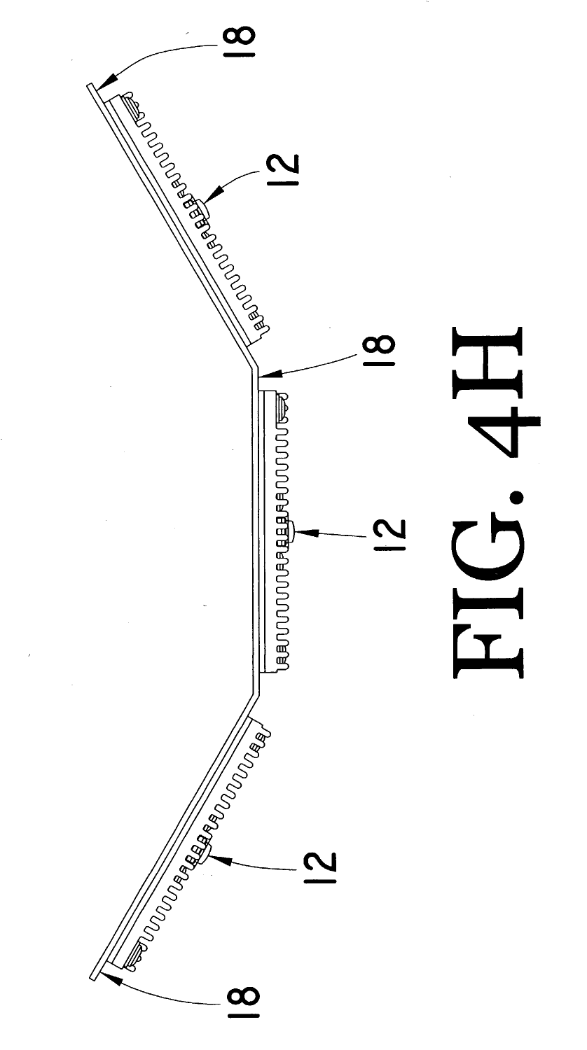

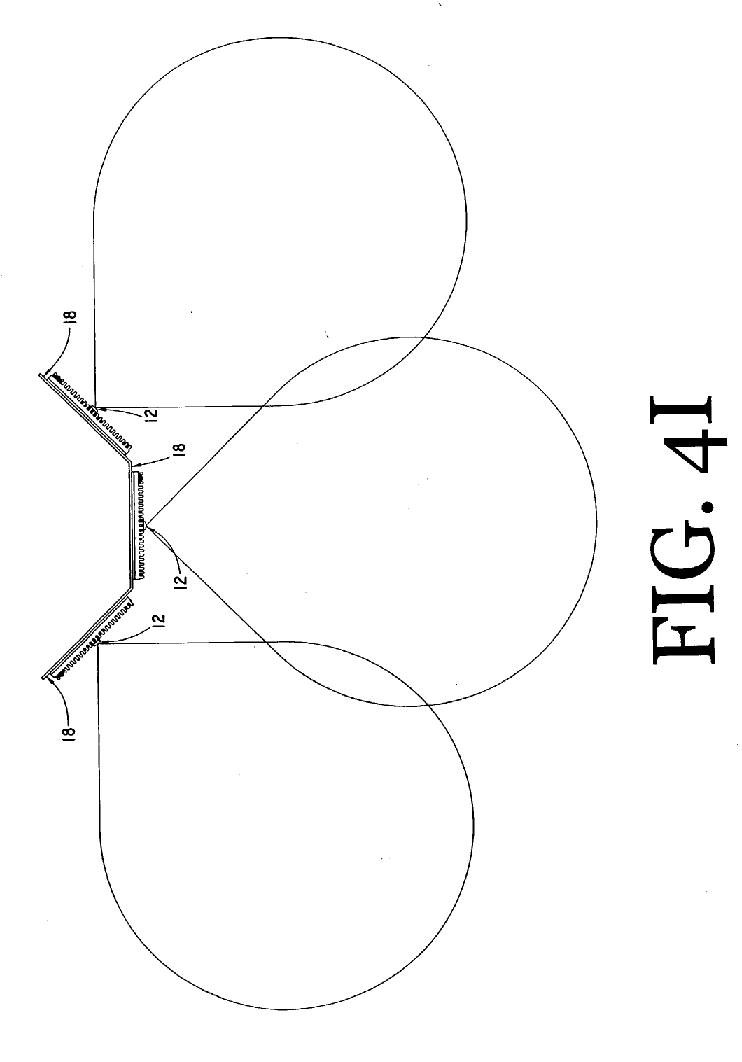

Referring now to FIGS. 4A through 41, therein are illustrated examples of alternate arrangements of Chassis 16 and Emission Faces 18. FIG. 4A, for example, has 8 horizontal Emission Faces 18, each having a vertical arrangement of four HBLEDs 12 and a top Emission Face 18 that may may hold between one and 5 HBLEDs 12. FIG. 4B, in turn, has six horizontal Emission Faces 18, each having four HBLEDS 12 and a top Emission Face 18 holding one to four HBLEDs 12. FIG. 4C is similar to that illustrated in FIG. 1A, but has a top Emission Face 18 that may hold two HBLEDs 12 rather than one. The examples illustrated in FIGS. 4D through 4F are similar respectively to those illustrated in FIGS. 4A through 4C, but the top Emission Faces 18 are domed to provide a corresponding domed top emission pattern. FIGS. 4G and 4H, in turn, are diagrammatic representations of HBLED Arrays 10 having concave and convex arrays of Emission Faces 18, thereby providing, respectively, a focused emission pattern, similar to a spotlight, and a distributed emission pattern, similar to a floodlight. In this regard, it should be noted that as illustrated in FIG. 41, HBLEDs 12 having an emission pattern of 45° to either side of the perpendicular to the face of the HBLED 12 may be arranged on Emission Faces 18 having angles between the faces of less than 90°, so that the emission patterns effectively overlap and thus increase the intensity of light in the overlap areas.

In present embodiments, the light emitting diodes provide emissions in the order of 15 to 20 lumens/watt for white light and 50 to 55 lumens/watt for yellow/orange light and consume power in the range of 1.2 watts at currents in the range of 350 milliamps at 5 to 12 volts, with the lower voltages preferred to reduce heat emissions. Examplary heat sinks presently have radiating surfaces of approximately 8 to 10 square inches, which may be increased to areas in the range of 14 to 15 square inches for more powerful LEDs, for example, or reduced somewhat where desirable or necessary.

Since certain changes may be made in the above described improved the laser beam or wave fronts, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A high brightness light emitting diode array, comprising:
a plurality of emission faces forming a chassis to provide a light emission pattern,
at plurality of heat sink assemblies, each heat sink assembly being attached to an emission face and having at least one high brightness light emitting diode mounted on the heat sink assembly,
the geometric arrangement of emission faces and the geometric arrangement of heat sink assemblies being selected to provide a desired emission pattern of the high brightness light emitting diodes mounted to the heat sink assemblies,
a power supply connected to the high brightness light emitting diodes to cause the emission of light from the high brightness light emitting diodes, and
a mechanical mounting connector and an electrical connection for providing power to the power supply.

2. The high brightness light emitting diode array of claim 1 wherein a heat sink assembly comprises:
a heat sink plate mountable to an emission face and having radiating fins for dissipating heat to surrounding air,
a high brightness light emitting diode mounted to the heat sink plate with a thermally conductive and electrically isolating element between the diode and the heat sink plate,
electrical conductors for providing power to the diode and connected from the diode and leading through the heat sink plate to a back side of the emission face, the electrical conductors being electrically insulated from the heat sink plate and the emission face,
fastenings for attaching the heat sink plate to the emission face, and
an electrical insulating plate between the heat sink plate and the emission face.
